(19) United States
(12) Patent Application Publication
(10) Pub. No.: US 2008/0277932 A1
(43) Pub. Date: Nov. 13, 2008

(54) Screw Connection and a Wire Thread Insert Therefore

(76) Inventors: Klaus Friedrich Grubert, Buckeburg (DE); Thomas Maciejowski, Werther (DE)

Correspondence Address: SEYFARTH SHAW LLP, 131 S. DEARBORN ST., SUITE 2400, CHICAGO, IL, 60603-5803, US

(21) Appl. No.: 11/629,577

(22) PCT Filed: Jun. 15, 2005
(86) PCT No.: PCT/EP2005/006446

§ 371 Date: Mar. 1, 2007

(30) Foreign Application Priority Data
Jun. 15, 2004 (DE) 20 2004 009 406.1

(51) Int. Cl. F16B 37/12

(52) U.S. Cl. 285/334

(57) ABSTRACT

A screw connection comprising a wire thread insert 8 which is inserted between a female thread M of a workpiece 4 and a male thread B of a screw 6 and which consists of a helically coiled wire thread member having a male thread adjacent internal thread 10 and a female thread adjacent external thread 12, characterized in that the profile angles β_{B}, β_{M} of the internal and external threads 10, 12 of the wire thread insert 8 are smaller than the respective profile angles α_{B}, α_{M} of the male thread B and, respectively, the female thread M such that when the screw connection is loaded by a predetermined biasing force K_{V} the load flanks of the internal and external threads 10, 12 of the wire thread insert 8 engage the associated load flanks of the male and female threads B, M in full contact relationship.

The present invention relates to a screw connection with a thread wire insert which is inserted between a female thread of a workpiece and a male thread of a screw as well as a thread wire insert for such a screw connection.

Such thread wire inserts are well-known, see e.g. EP 0 983 445 B1 with further references. They consist of a helically coiled wire thread member with a male thread adjacent internal thread and a female thread adjacent external thread. The profile angles of the inner and outer thread of the wire thread insert are normally identical to the profile angles of the male thread and the female thread.

If these wire thread inserts have proved themselves very well in practice, however certain improvements with regard to their functionality and in particular with regard to the thread bearing capacity of such wire thread inserts would be desirable.

The present invention is based on the object of further developing a screw connection of the named type and the associated wire thread insert in such a way that they are improved by an optimization of the thread profile with regard to functionality and in particular with regard to thread bearing capacity.

This object is solved by the invention defined in claim 1.

In accordance with the invention the profile angles of the inside and outside thread of the wire thread insert are smaller than the respective profile angle of the male thread and female thread.

The present invention starts from the recognition that in the prior art, in which the profile angles of the wire thread insert are identical to the profile angle of the male and female thread, the transfer of force from the male thread to the receiving thread does not take place in full contact relationship, but rather more in point contact. The cause for this lies in a torsion-shaped deformation of the wire thread insert when the screw connection is loaded by a pre-determined biasing force, as will be explained in greater detail later.

In contrast to this in the case of the screw connection designed according to the invention a corresponding torsion-shaped distortion of the wire thread insert on the basis of said angle difference between the profile angles leads to a full surface contact of the load flanks of the wire thread insert on the associated load flanks of the male and female thread. As a result the screwing force is more uniformly distributed on the load flanks of the thread. Local overloads of the thread bearing surfaces are prevented, so that settling effects in the material of the female thread, as they occur in the prior art on the basis of the point load transfer, are reduced. As a result of this higher residual biasing forces are preserved over the service life of the screw connection.

According to the invention consequently the following advantages arise compared to the prior art:
a) realization of higher biasing forces on the basis of lower specific load of the thread flanks in the screw connection
b) increased residual biasing force on the basis of lower settling effects in the thread flanks of the screw connection
c) more uniform distribution of the biasing force to all thread flanks of the screw connection.

In a further design of the invention provision is made that the profile angle of the internal thread of the wire thread insert is 0.80-0.93 times that of the profile angle of the male thread and that the profile angle of the external thread of the wire thread insert is 0.83-0.96 times that of the profile of the female thread. In the case of a profile angle of 60° for the male and female thread the profile angle of the internal thread of the wire thread insert is preferably in the order of 52°±4° and the profile angle of the external thread of the wire thread insert is preferably in the order of 54°±4°.

Additional advantageous designs of the invention result from the sub-claims.

With the help of the drawings the invention will be more closely described. In the figures:

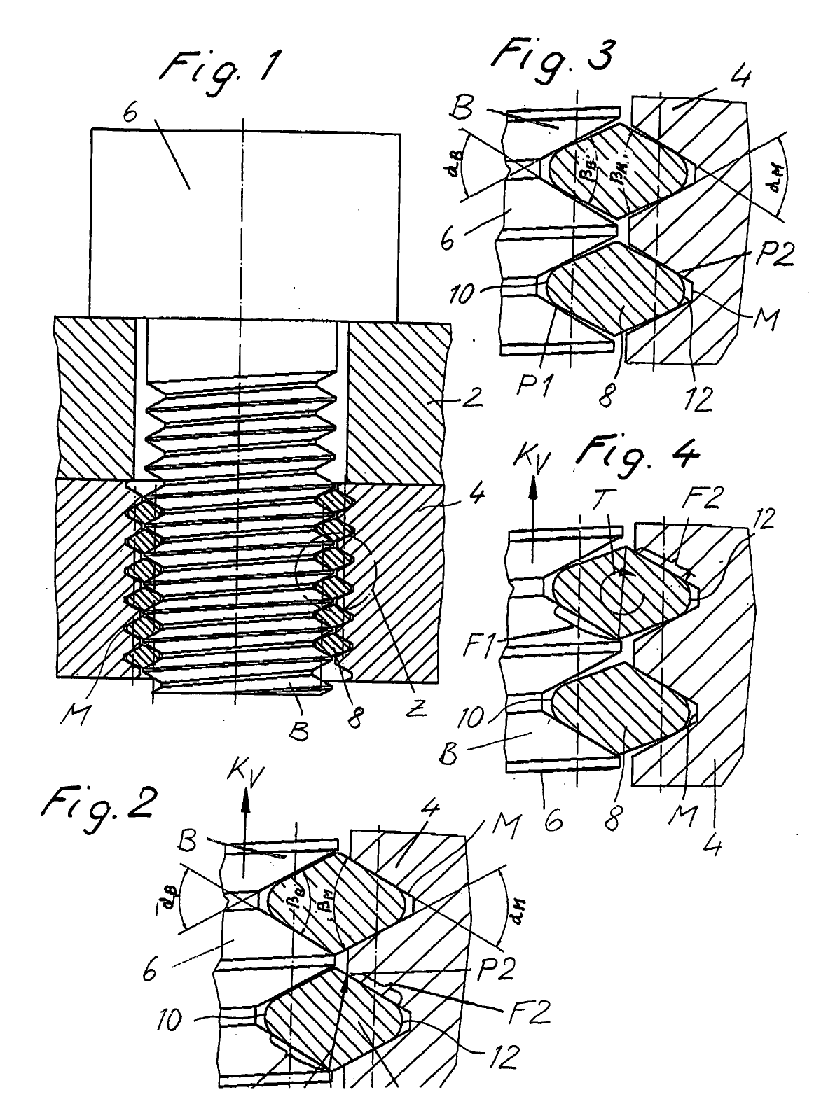

FIG. 1 shows a longitudinal section through a thread connection with a wire thread insert;

FIG. 2 shows an enlarged representation of the region designated with the dash and dot line circle Z in FIG. 1 of a screw connection of the prior art;

FIG. 3 shows a view corresponding to FIG. 2 of a screw connection designed according to the invention in unloaded state;

FIG. 4 shows a representation corresponding to FIG. 2 of the screw connection designed according to the invention of FIG. 3 in loaded state.

The screw connection represented in FIG. 1 serves the purpose of connection of two workpieces 2, 4 and has a screw 6, whose thread shaft has a male thread B. The thread shaft of the screw 6 is inserted through a slot of the workpiece 2 and screwed via a wire thread insert 8 to the female thread M of the workpiece 4.

As can be seen in FIG. 1, and even better in FIG. 2, the wire thread insert 8 has an internal thread 10 and an external thread 12, said threads interacting in biased state of the screw connection with the male thread B of the screw 6 and the female thread M of the workpiece 4.

In FIG. 2 in particular the profile angles of the associated threads of a conventionally designed screw connection are shown. As already initially mentioned, in the prior art the profile angles β_{B} and β_{M} of the wire thread insert 8 are identical to the profile angles α_{B} and α_{M} of the male thread B and the female thread M.

When in this case the screw connection is loaded with a biasing force Kᵥ, the force of the male thread B is transferred to the female thread M along a line of application K; the theoretically existing force transfer surfaces F1 and F2 on the load flanks of the thread are in this connection substantially relieved from forces.

If one leaves bearing surface enlarging deformations on the male thread B and female thread M unconsidered, the transfer of force takes place selectively over points P1 and P2. The screw line running through the points P1 and P2 is therefore specifically highly loaded, which leads to a plastic deformation of the material over time. Through this appearing plastic deformation an enlargement of the force transfer surfaces then arises. Disadvantageous consequences are settling effects in the female thread, in particular in the case of relaxation-endangered materials like magnesium alloys. These settling effects lead to a loss in biasing force Kᵥ (see FIG. 4).

In contrast to this in the case of the screw connection shown in FIG. 3 provision is made according to the invention that the profile angles β_{B} and β_{M} of the wire thread insert 8 respectively are smaller than the associated profile angles α_{B} or α_{M} of the male thread B and female thread M. This angle difference of the profile angles is schematically represented in FIG. 3.

If the screw connection is now loaded with a biasing force Kᵥ (see FIG. 4) by tightening of the screw 6, the transfer of force of the male thread B to the female thread M takes place first over the points P1 and P2. When the biasing force Kᵥ is completely applied, the profile of the wire thread insert 8 is elastically twisted or torsion deformed, as is indicated by the circular line T in FIG. 4. A full surface contact then happens between the load flanks of the thread 10, 12 of the wire thread insert 8 and the male thread B and the female thread M in the region of the force transfer surfaces F1 and F2. As a result a large contact surface on the load flanks of the male thread B and the female thread M is achieved. The result is a lower specific load of the thread flanks with the connected settling effects in particular on the thread flanks of the receiving thread (female thread M).

As arises from the above explanation, the angle difference between the profile angle β_{B} of the external thread 10 of the wire thread insert 8 and the profile angle α_{B} of the male thread as well as the angle difference between the profile angle β_{M} of the external thread 12 of the wire thread insert 8 and the profile angle α_{M} of the female thread M is selected in such a way that in the loaded state of the screw connection the desired full surface contact between the load flanks to the transfer of force surfaces F1 and F2 results. Preferably the profile angle β_{B} of the internal thread 10 of the wire thread insert 8 is 0.80 to 0.93 times that of the profile angle α_{B} of the male thread B. Preferably further the profile angle β_{M} of the external thread 12 of the wire thread insert 8 is 0.83 to 0.93 times that of the profile angle α_{M} of the female thread M.

In the case of a metric ISO thread in accordance with DIN 13 the standard angle is 60°. Thus if one selects the standard angle of 60° for the male thread B and the female thread M, the desired angle difference of the profile angles is achieved through a corresponding reduction of the profile angles of the wire thread insert 8. Expediently then the profile angle β_{B} of the internal thread 10 of the wire thread insert 8 is in the order of 52°±4° and the profile angle β_{M} of the external thread 12 of the wire thread insert 8 is in the order of 54°±4°.

However, it is understood that the desired angle difference can also be achieved by selecting the standard angle for the profile angles of the wire thread insert while the profile angles of the male and female thread are correspondingly enlarged compared to the standard angle.

As initially mentioned, the invention has the advantage of a more uniform distribution of the biasing force to all thread flanks, which enables the realization of higher biasing forces as well as an increased residual biasing force on the basis of reduced settling effects in the thread flanks. This all leads to an increased service life of the thread connection.

In order to further increase the fatigue durability of the thread connection, a pitch difference between the male thread B and the female thread M can be provided in such a way that the thread pitch of the male thread b is less than that of the thread pitch of the female thread M. This pitch difference is selected in such a way that on the basis of the elongation of the thread shaft of the screw 6 in biased condition the pitches of the male thread and female thread approximate each other. As a result of this a concentration of force in the first thread course, as results from prior art, is prevented; rather there is a uniform transfer of force to all thread courses of the screw connection.

In order to achieve this pitch difference between male and female thread the female thread can be given a greater pitch than the standard pitch of the associated thread. However, instead of that the male thread can also be given a smaller pitch than the standard pitch of the associated thread.

An additional possibility for increasing the service life of the screw connection consists in designing the profile angle β_{M} of the female thread M to vary over its length, to be precise in such a way that the angle difference between the profile angle β_{M} of the external thread 12 of the wire thread insert 8 and of said female thread M decreases with increasing depth of insertion of the screw thread insert. Through this profile angle of the female thread M variable over its length as it were a load build up of the screw connection from below can be achieved (in FIG. 1).

1. A screw connection comprising a wire thread insert which is inserted between a female thread (M) of a workpiece and a male thread of a screw and which consists of a helically coiled wire thread member having a male thread adjacent internal thread and a female thread adjacent external thread, wherein the profile angles of the internal and external threads of the wire thread insert are smaller than the respective profile angle of the male thread and, respectively, the female thread such that when the screw connection is loaded by a predetermined biasing force the load flanks of the internal and external threads of the wire thread insert engage the associated load flanks of the male and female threads in full contact relationship, characterized in that the profile angle of the internal thread of the wire thread insert is 0.80-0.93 times the profile angle of said male thread, and the profile angle of the external thread of the wire thread insert is 0.83-0.96 times the profile angle of said female thread.

2. The screw connection according to claim 1, wherein when said male and female threads have profile angles of 60° the profile angle of the internal thread of the wire thread insert is in the order of 52°±4° and the profile angle of the external thread of the wire thread insert is in the order of 540±40.

3. The screw connection according to claim 1 wherein the profile angles of the male thread and of the female thread have standard profile angles and the profile angles of the wire thread insert are different from standard profile angles.

4. The screw connection according to any one of claim 1, wherein the profile angles of the wire thread insert are standard profile angles and the profile angles of the male thread and female thread are different from standard profile angles.

5. The screw connection according to claim 1, wherein the pitch of the male thread is less than the pitch of the female thread so that the two pitches are substantially the same when the screw connection is in a biased condition.

6. The screw connection of claim 7, wherein the pitch of said female thread is greater than a standard pitch or the pitch of said male thread is smaller than a standard pitch of the respective thread.

7. The screw connection according to claim 1, characterized in that wherein the profile angle of said female thread varies over its length such that the angle difference between the profile angles of the external thread of the wire thread insert and of said female thread decreases with increasing depth of insertion of the wire thread insert.

8. A wire thread insert for a screw connection according to claim 1, wherein the profile angles of the internal and external threads of the wire thread insert are less than the standard profile angles of the respective thread.
